(19) United States
(12) Patent Application Publication
(10) Pub. No.: US 2025/0036486 A1
(43) Pub. Date: Jan. 30, 2025

(54) DATA RACE DETECTION METHOD AND APPARATUS

(71) Applicant: ELECTRONICS AND TELECOMMUNICATIONS RESEARCH INSTITUTE, Daejeon (KR)

(72) Inventors: Dong-Wook KANG, Daejeon (KR); Gae-Il AN, Daejeon (KR); Hong-Il JU, Daejeon (KR)

(73) Assignee: ELECTRONICS AND TELECOMMUNICATIONS RESEARCH INSTITUTE, Daejeon (KR)

(21) Appl. No.: 18/917,040

(22) Filed: Oct. 16, 2024

(30) Foreign Application Priority Data
May 31, 2021 (KR) 10-2024-0071437
Nov. 20, 2023 (KR) 10-2023-0160345

(51) Int. Cl. G06F 9/52

(52) U.S. Cl. CPC G06F 9/524

(57) ABSTRACT

Disclosed herein are a data race detection method and apparatus. The data race detection method includes recording information about an instruction executed by a thread in a destination register in a Central Processing Unit (CPU) corresponding to the thread, setting information of an access log field corresponding to the instruction for a cache line of a cache memory, and detecting a data race using the information of the access log field and information of the destination register.

### CROSS REFERENCE TO RELATED APPLICATIONS

This application claims the benefit of Korean Patent Application Nos. 10-2023-0160345, filed Nov. 20, 2023 and 10-2024-0071437, filed May 31, 2024, which are hereby incorporated by reference in their entireties into this application.

### BACKGROUND OF THE INVENTION

### 1. Technical Field

The present disclosure relates generally to an apparatus and method that detect a data race occurring in multiple threads or processes.

More particularly, the present disclosure relates to a method for detecting a data race using a memory source address and lock information.

### 2. Description of the Related Art

A data race may refer to a software bug in which the corresponding memory access includes one or more write accesses when two or more threads or processes concurrently access the same memory area without synchronization.

Because a data race may lead to severe software malfunctioning or attack damage, various detection technologies have been proposed, but unresolved problems such as considerable performance overhead remain before commercialization thereof. Representative examples of data race detection technology include Google's TSAN and Intel's Inspector. However, TSAN causes a performance degradation of around 12 times, and Inspector leads to a performance degradation of 200 times.

As a result, there is urgently required a data race detection method with lower overhead and false positive rates.

### PRIOR ART DOCUMENTS

### Patent Documents

(Patent Document 1) Korean Patent Application Publication No. 2016-0063373 (Title: Techniques for Detecting Race Conditions)

### SUMMARY OF THE INVENTION

Accordingly, the present disclosure has been made keeping in mind the above problems occurring in the prior art, and an object of the present disclosure is to provide a method for accurately detecting a data race while having low overhead.

In accordance with an aspect of the present disclosure to accomplish the above object, there is provided a data race detection method performed by a data race detection apparatus, the data race detection method including recording information about an instruction executed by a thread in a destination register in a Central Processing Unit (CPU) corresponding to the thread; setting information of an access log field corresponding to the instruction for a cache line of a cache memory; and detecting a data race using the information of the access log field and information of the destination register.

The access log field may include a thread identifier (ThrID) field, a writing/non-writing (W) field, and a bitmap field.

Setting the information in the access log field may include, when the instruction performs memory writing, entering a thread in which an instruction is executed into the thread identifier field, entering true (1) into the writing/non-writing field, and entering information into the bitmap field to correspond to an area of the instruction for performing memory writing.

Detecting the data race may include determining whether there is a cache line corresponding to a source address of a general-purpose register having a source value of the instruction for performing the memory writing.

Detecting the data race may further include, when there is the cache line corresponding to the source address of the general-purpose register, determining whether there is a first access log in which a thread identifier field of the cache line is identical to a thread identifier of a thread executing the instruction and in which a value of a writing/non-writing field is false (0) and a bitmap field corresponds to an area of the instruction for performing the memory writing.

Detecting the data race may further include, in a case where there is the first access log, determining that the data race has occurred when, among access logs inserted after the first access log, there is a second access log in which the thread identifier field of the cache line is different from the thread field of the thread executing the instruction and in which the value of the writing/non-writing field is true (1) and the bitmap field corresponds to the area of the instruction for performing the memory writing.

Recording the information in the designation register in the CPU may include, when executing an instruction for loading data from a memory into the destination register of the CPU, recording a memory address; and when executing an instruction for writing a result of an operation to the destination register using a value of a source register, copying an address register value of the source register to an address register of the destination register.

Copying the address register value to the address register of the destination register may include, when multiple source register values are used, coping address register values corresponding to the multiple source register values, respectively.

Copying the address register value to the address register of the destination register may include inputting 0 to the address register of the destination register when a constant is used as an operand.

In accordance with another aspect of the present disclosure to accomplish the above object, there is provided a data race detection method performed by a data race detection apparatus, the data race detection method including, in response to a lock setting instruction or a lock release instruction of a thread, managing lock information in a Central Processing Unit (CPU) corresponding to the thread; setting information in an access log field corresponding to an instruction of the thread for a cache line of a cache memory; and detecting a data race using the information of the access log field and the lock information.

The lock information may include a next lock identifier (next_lockID) register value, a number-of-locks (num_locks) register value, and a lock log table, and the lock log table may include a lock identifier (lockID) field and a lock tag (LockTag) field.

The access log field may include a thread identifier (ThrID) field, a writing/non-writing (W) field, and a bitmap field.

Managing the lock information may include, when the instruction of the thread corresponds to the lock setting instruction, setting a lock identifier (LockID) value to the next lock identifier (next_lockID) register value, setting a lock tag (LockTag) value to a source register tag value, and increasing the next lock identifier (next_lockID) register value and the number-of-locks (num_locks) register value by 1.

Detecting the data race may include, when the instruction of the thread performs memory writing, determining whether there is an access log in which a thread identifier field of the cache line is different from a thread identifier of the thread executing the instruction, and a bitmap field includes a memory access area of the instruction for performing the memory writing.

Detecting the data race may include, when the instruction of the thread performs memory reading, determining whether there is an access log in which a thread identifier field of the cache line is different from the thread identifier of the thread executing the instruction and in which the bitmap field includes a memory access area of the instruction for performing memory reading and a value of the writing/non-writing field is true (1).

Detecting the data race may further include checking whether the lock identifier is in an occupied state based on the lock log table corresponding to the thread identifier field value of the cache line.

In accordance with a further aspect of the present disclosure to accomplish the above object, there is provided a data race detection apparatus, including one or more processors; and an execution memory configured to store at least one program that is executed by the one or more processors, wherein the at least one program includes instructions for performing recording information about an instruction executed by a thread in a destination register in a Central Processing Unit (CPU) corresponding to the thread; setting information of an access log field corresponding to the instruction for a cache line of a cache memory; and detecting a data race using the information of the access log field and information of the destination register.

In accordance with yet aspect of the present disclosure to accomplish the above object, there is provided a data race detection apparatus, including one or more processors; and execution memory configured to store at least one program that is executed by the one or more processors, wherein the at least one program includes instructions for performing, in response to a lock setting instruction or a lock release instruction of a thread, managing lock information in a CPU corresponding to the thread, setting information in an access log field corresponding to the instruction of the thread for a cache line of cache memory, and detecting a data race using the information of the access log field and the lock information.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flowchart illustrating a data race detection method according to an embodiment of the present disclosure;

FIG. 2 is a flowchart illustrating a data race detection method according to another embodiment of the present disclosure;

FIG. 3 is a configuration diagram illustrating a data race detection apparatus according to an embodiment of the present disclosure;

FIG. 4 is a diagram illustrating the structure of a CPU for performing a data race detection method according to an embodiment of the present disclosure;

FIG. 5 is a diagram illustrating the structure of a cache for performing a data race detection method according to an embodiment of the present disclosure;

FIG. 6 is a flowchart illustrating a method for driving a memory source address management unit;

FIGS. 7 and 8 are flowcharts illustrating the operation of a source address-based data race detection unit;

FIG. 9 is a flowchart illustrating a method for driving a lock information management unit;

FIGS. 10 and 11 are flowcharts illustrating the operation of a lock identifier (lockID)-based data race detection unit;

FIGS. 12 to 15 illustrate a first embodiment of a memory source address management unit and a source address (srcAddr)-based data race detection unit;

FIGS. 16 to 19 illustrate a second embodiment of a memory source address management unit and a source address (srcAddr)-based data race detection unit;

FIGS. 20 to 23 illustrate a first embodiment of a lock information management unit and a lock identifier (lockID)-based data race detection unit;

FIGS. 24 to 27 illustrate a second embodiment of a lock information management unit and a lock identifier (lockID)-based data race detection unit; and

FIG. 28 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Hereinafter, embodiments of the present disclosure will be described in detail with reference to the accompanying drawings. In the following description of the present disclosure, the same reference numerals are used to designate the same or similar elements throughout the drawings and repeated descriptions of the same components will be omitted.

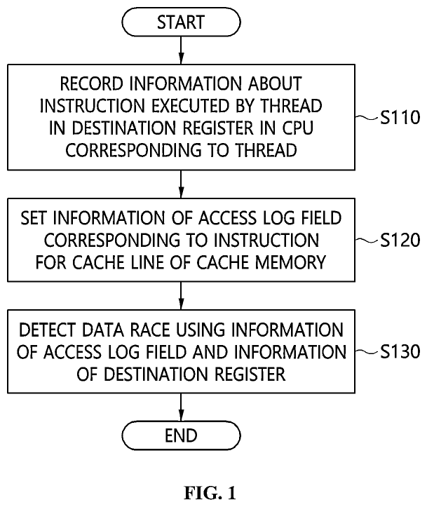

FIG. 1 is a flowchart illustrating a data race detection method according to an embodiment of the present disclosure.

The data race detection method according to the embodiment of the present disclosure may be performed by a data race detection apparatus such as a computing device.

Referring to FIG. 1, the data race detection method according to the embodiment of the present disclosure may include step S110 of recording information about an instruction executed by a thread in a destination register in a Central Processing Unit (CPU) corresponding to the thread, step S120 of setting information of an access log (record) field corresponding to the instruction for a cache line of cache memory, and step S130 of detecting a data race using the information of the access log field and the information of the destination register.

Here, the access log field may include a thread identifier (ThrID) field, a writing/non-writing (W) field, and a bitmap field.

Here, step S120 of setting the information of the access log field may include, when the instruction performs memory writing, entering a thread executing the instruction to the thread identifier field, entering true (1) into the writing/non-writing field, and entering information into the bitmap field to correspond to the area of the instruction for performing memory writing.

Here, at step S130 of detecting the data race, whether there is a cache line corresponding to the source address of a general-purpose register having a source value of the instruction for performing memory writing may be determined.

Here, at step S130 of detecting the data race, when there is the cache line corresponding to the source address of the general-purpose register, it may be determined whether there is a first access log in which the thread identifier field of the cache line is the same as the thread identifier of the thread executing the instruction and in which the value of the writing/non-writing field is false (0) and the bitmap field corresponds to the area of the instruction for performing memory writing.

Here, at step S130 of detecting the data race, when there is the first access log, it may be determined that a data race has occurred when, among access logs inserted after the first access log, there is a second access log in which the thread identifier field of the cache line is different from the thread field of the thread executing the instruction and in which the value of the writing/non-writing field is true (1) and the bitmap field corresponds to the area of the instruction for performing memory writing.

Here, step S110 of recording in the designation register in the CPU may include the step of when an instruction for loading data from the memory into the destination register of the CPU is executed, recording a memory address, and the step of, when executing an instruction for writing operation results to the destination register using the value of the source register, copying the address register value of the source register to the address register of the destination register.

Here, at the step of copying to the address register of the destination register may include, when multiple source register values are used, address register values corresponding to the multiple source register values may be copied, respectively.

Here, at the step of copying to the address register of the destination register, 0 may be input to the address register of the destination register when a constant is used as an operand.

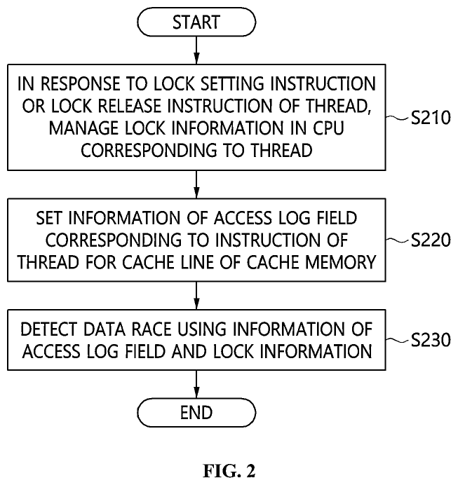

FIG. 2 is a flowchart illustrating a data race detection method according to another embodiment of the present disclosure.

Referring to FIG. 2, the data race detection method according to the embodiment of the present disclosure may include step S210 of, in response to a lock setting instruction or a lock release instruction of a thread, managing lock information in a CPU corresponding to the thread, step S220 of setting information in an access log field corresponding to the instruction of the thread for a cache line of cache memory, and step S230 of detecting a data race using the information of the access log field and the lock information.

Here, the lock information may include a next lock identifier (next_lockID) register value, the number-of-locks (num_locks) register value, and a lock log (record) table, and the lock log table may include a lock identifier (lockID) field and a lock tag (LockTag) field.

Here, the access log field may include a thread identifier (ThrID) field, a writing/non-writing (W) field, a lock identifier field, and a bitmap field.

Here, at step S210 of managing the lock information, when the instruction of the thread corresponds to the lock setting instruction, the value of the lock identifier (LockID) field may be set to the next lock identifier (next_lockID) register value, the value of the lock tag (LockTag) field may be set to a source register tag value, and the values of the next lock identifier (next_lockID) register and the number-of-locks (num_locks) register may be increased by 1.

Here, at step S230 of detecting the data race, when the instruction of the thread performs memory writing, it may be determined whether there is an access log in which the thread identifier field of the cache line is different from the thread identifier of the thread executing the instruction and in which the bitmap field includes the memory access area of the instruction for performing memory writing.

Here, at step S230 of detecting the data race, when the instruction of the thread performs memory reading, it may be determined whether there is an access log in which the thread identifier field of the cache line is different from the thread identifier of the thread executing the instruction and in which the bitmap field includes the memory access area of the instruction for performing memory reading and the value of the writing/non-writing field is true (1).

Here, at step S230 of detecting the data race, whether the lock identifier is in an occupied state may be determined based on the lock log table corresponding to the thread identifier field value of the cache line.

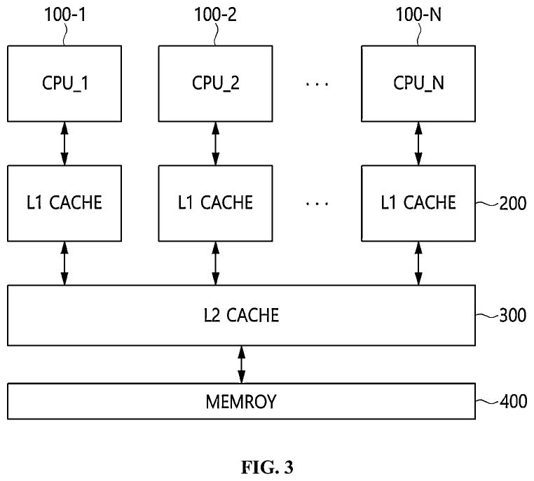

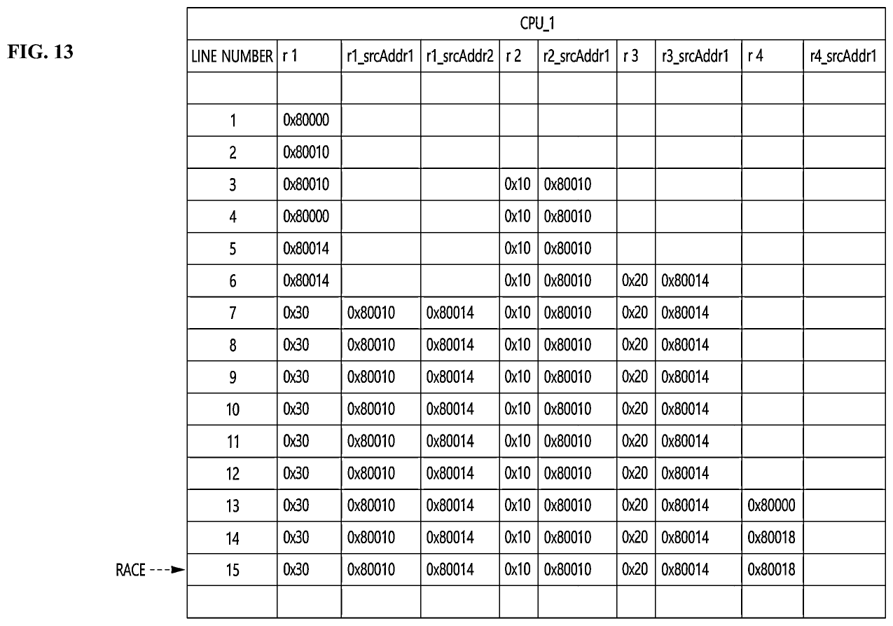

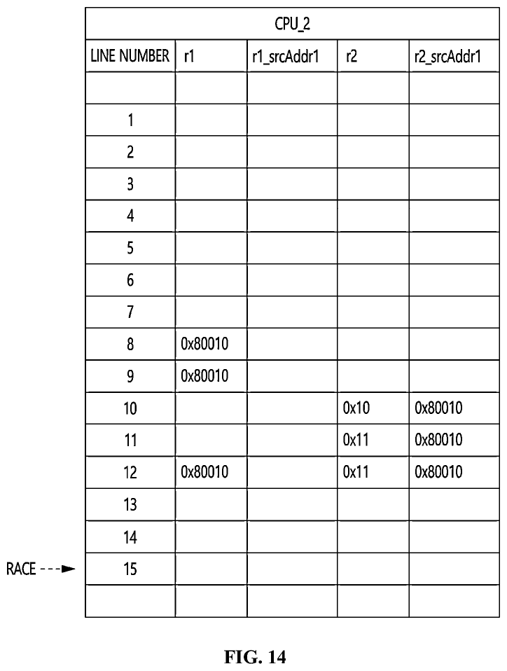

Hereinafter, embodiments of the present disclosure will be described in detail with reference to FIG. 3 to FIG. 14.

FIG. 3 is a configuration diagram illustrating a data race detection apparatus according to an embodiment of the present disclosure.

Referring to FIG. 3, a data race detection method according to an embodiment of the present disclosure may be performed by a system including a CPU 100, caches 200 and 300, and memory 400.

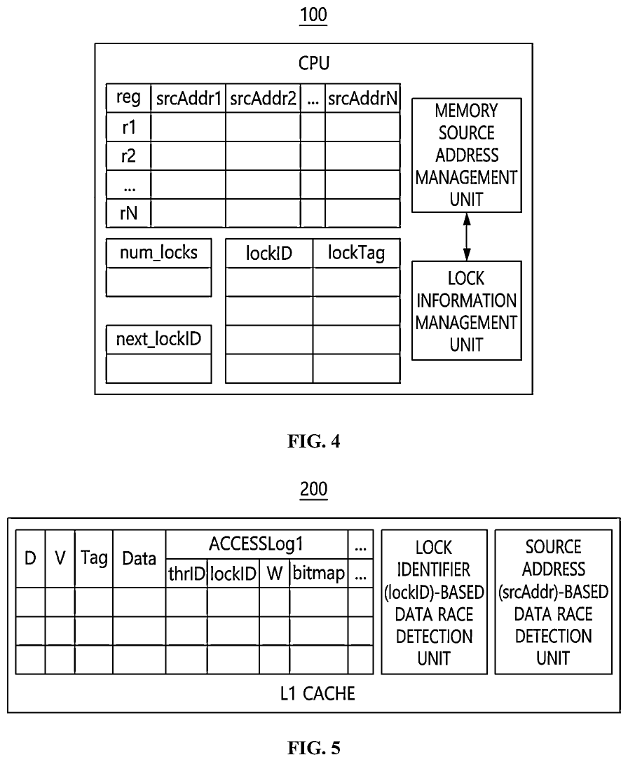

FIG. 4 is a diagram illustrating the structure of a CPU for performing a data race detection method according to an embodiment of the present disclosure.

FIG. 5 is a diagram illustrating the structure of a cache for performing a data race detection method according to an embodiment of the present disclosure.

Referring to FIG. 4, in order to perform data race detection in the method according to the embodiment of the present disclosure, source address size SRC_ADDR_SIZE source address (srcAddr) registers, such as srcAddr1, srcAddr2, . . . , srcAddrN, are added to each general-purpose register of the CPU 100. Also, a lock log (LockLog) table composed of the number-of-locks (num_locks) register, a next lock identifier (next_lockID) register, and lock log size (LOCK_LOG_SIZE) lock identifier (lockID) registers and log tag (LockTag) registers is added.

Referring to FIG. 5, ACCESS_LOG_SIZE access log (AccessLog) field groups, such as AccessLog1, AccessLog2, and AccessLog3, are added to each cache line of cache memory such as L1 cache and L2 cache, and are each composed of a thread identifier (thrID) field, a lock identifier (lockID) field, a writing/non-writing (W) field, and a bitmap field. Also, when data in each cache line is moved/copied between cache layers according to the cache memory operation method, AccessLog field groups are moved/copied together with the data.

Further, a memory source address management unit and a lock information management unit are added to the CPU 100, and a lock identifier (lockID)-based data race detection unit and a source address (srcAddr)-based data race detection unit are added to each of the caches 200 and 300.

The source address (srcAddr)-based data race detection unit detects a data race that is currently occurring by utilizing information collected by the memory source address management unit, and the lock identifier (lockID)-based data race detection unit also detects code in which a data race may occur during re-execution, as well as a data race that is currently occurring, by utilizing information collected by the lock information management unit. Therefore, the memory source address management unit and the source address (srcAddr)-based data race detection unit may be basically executed, and the lock information management unit and the lock identifier (lockID)-based data race detection unit may be executed when it is desired to detect code in which a data race may potentially occur.

The number of CPU cores, the number of caches and memory layers, etc. in the configuration diagram may be different from those illustrated in the configuration diagram.

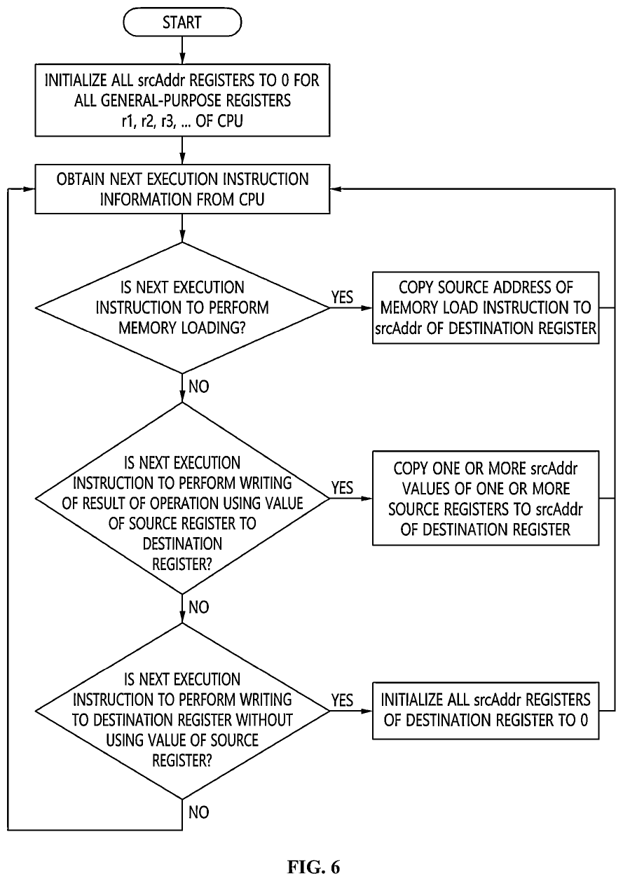

FIG. 6 is a flowchart illustrating a method for driving a memory source address management unit.

The memory source address management unit initializes all source address registers for all general-purpose registers of the CPU to 0, and obtains next execution instruction information from the CPU.

In SRC_ADDR_SIZE source address (srcAddr) registers added to the CPU by the memory source address management unit, memory addresses are recorded when an instruction for loading data from memory into the CPU registers is executed. For example, the following load instruction is intended to perform a task for reading data at a memory address, obtained by adding the value of an rs1 register to the value of imm_offset, and writing the read data to an rd register, wherein the sum of the value of the rs1 register and the value of imm_offset is recorded in the source address (srcAddr) register of the rd register.
load rd, rs1, imm_offset

In this case, when an instruction for utilizing the value of the source register as an operand and writing the result of the operation to the destination register is executed, the source address (srcAddr) register value of the source register corresponding to the operand is copied to the source address (srcAddr) of the destination register. For example, the following addi instruction performs a task for writing the result of adding the value of the rs1 register to 4 to the rd register, wherein values set at the source address (srcAddr) of the rs1 register are copied to the source address (srcAddr) of the rd register.
addi rd, rs1, 4

In another example, the following add instruction performs a task for writing the result of adding the value of the rs1 register to the value of the rs2 register to the rd register, wherein values set at the source address (srcAddr) of the rs1 register and values set at the source address (srcAddr) of the rs2 register are copied to the source address (srcAddr) of the rd register. Here, when the number of source addresses (srcAddr) of the rd register is insufficient, only some of the source addresses may be copied.
add rd, rs1, rs2

Furthermore, when an instruction for utilizing a constant value as an operand and writing the result of the operation to the destination register is executed, 0 is written to all of source addresses (srcAddr) of the destination register. For example, the following lui instruction performs a task for writing a value obtained by performing a 12-bit left shift operation on a 20-bit constant value included in the instruction to the rd register, wherein all of SRC_ADDR_SIZE source addresses (srcAddr) of the rd register become 0.
lui rd, 0x80

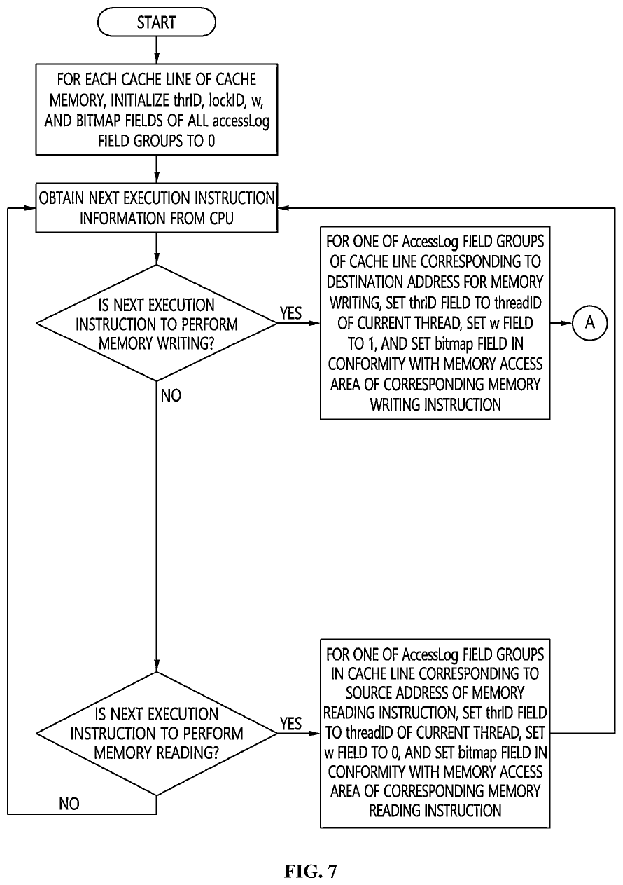

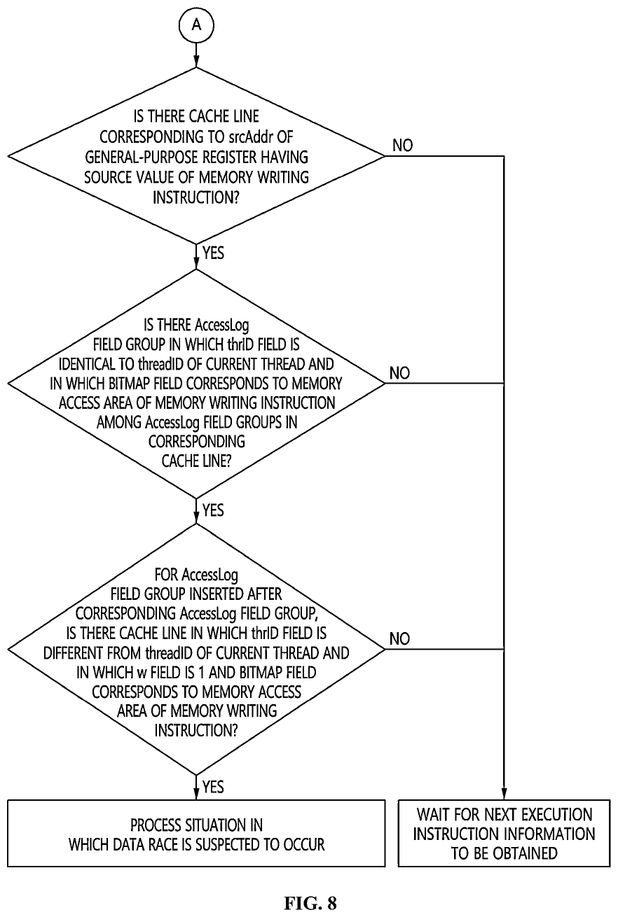

FIGS. 7 and 8 are flowcharts illustrating the operation of a source address-based data race detection unit.

When a memory writing or reading instruction is executed by the CPU after thread identifier (thrID) fields, lock identifier (lockID) fields, writing/non-writing (w) fields, and bitmap fields of all AccessLog field groups are initialized to 0 for each cache line of cache memory, as shown in FIG. 7, the source address (srcAddr)-based data race detection unit is operated as follows.

If a cache line corresponding to a destination address for memory writing is not present when the CPU executes the memory writing instruction, thread identifier (thrID) fields, lock identifier (lockID) fields, writing/non-writing (w) fields, and bitmap fields of all AccessLog field groups are initialized to 0 for a cache line allocated for the corresponding memory writing. (memory writing-AccessLog initialization)

Thereafter, for one of AccessLog field groups of the cache line corresponding to the destination address for memory writing, the thread identifier (thrID) field is set to the threadID of the current thread, the writing/non-writing (w) field is set to 1, and the bitmap field is set in conformity with the memory access area of the corresponding memory writing instruction. (memory writing-recording in AccessLog)

Thereafter, whether a cache line corresponding to the source address (srcAddr) of a general-purpose register having a source value for memory writing is present in the cache memory is determined. If there is no cache line, the source address-based data race detection unit waits for next execution instruction information to be obtained from the CPU. (memory writing-existing AccessLog-based data race detection)

If there is the cache line, the source address-based data race detection unit determine whether there is an AccessLog field group in which the thread identifier (thrID) field is identical to threadID of the current thread and in which the writing/non-writing (w) field is 0 and the bitmap field corresponds to the memory access area of the memory writing instruction, among AccessLog field groups of the corresponding cache line, and waits for next execution instruction information to be obtained from the CPU when there is no AccessLog field group.

When there is the AccessLog field group, the source address-based data race detection unit determines whether, for AccessLog field groups inserted after the corresponding AccessLog field group, there is cache line in which the thread identifier (thrID) field is different from threadID of the current thread and in which the writing/non-writing (w) field is 1 and the bitmap field corresponds to the memory access area of the memory writing instruction, and waits for next execution instruction information to be obtained from the CPU when there is no cache line.

When there is the cache line, the source address-based data race detection unit determines that a data race is suspected to occur, performs the corresponding processing, and thereafter waits for next execution instruction information to be obtained from the CPU.

If a cache line corresponding to the source address of a memory reading instruction is not present when the CPU executes the memory reading instruction, the thread identifier (thrID) fields, lock identifier (lockID) fields, writing/non-writing (w) fields, and bitmap fields of all AccessLog field groups are initialized to 0 for a cache line allocated for the corresponding memory reading. (memory reading-AccessLog record)

When there is the cache line, this process is skipped, and for one of AccessLog field groups of the cache line corresponding to the source address for memory reading, the source address-based data race detection unit sets the thread identifier (thrID) field to the threadID of the current thread, sets the writing/non-writing (w) field to 1, and sets the bitmap field in conformity with the memory access area of the corresponding memory reading instruction. Thereafter, the source address-based data race detection unit waits for next execution instruction information to be obtained from the CPU.

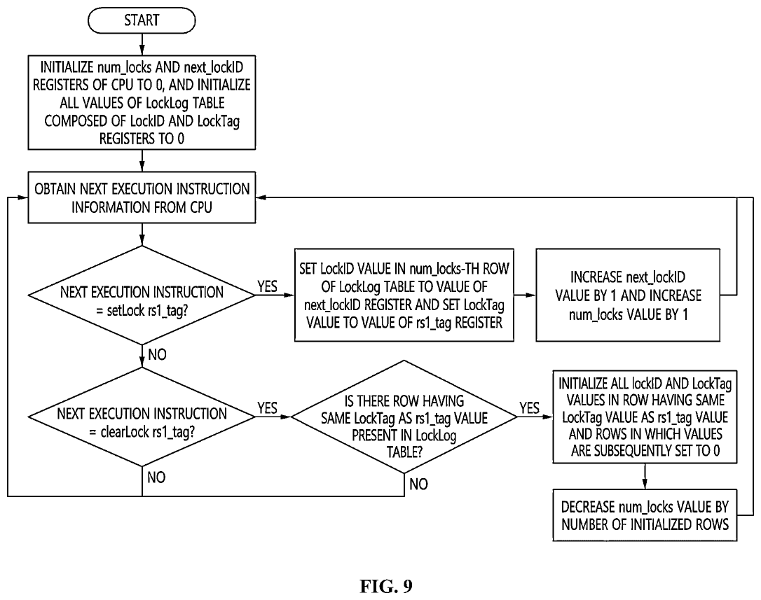

FIG. 9 is a flowchart illustrating a method for driving a lock information management unit.

The lock information management unit is operated when the following two newly added instructions are executed on the CPU.
setLock rs1_tag
clearLock rs1_tag

When the next execution instruction of the CPU is “setLock rs1_tag”, the lock information management unit sets a lock identifier (lockID) value in a num_locks-th row of a LockLog table to the value of a next_lockID register, and sets a lock tag (LockTag) value to the value of an rs1_tag register. Also, the lock information management unit increases the values of the next_lockID register and the number-of-locks (num_locks) register by 1.

Further, when a row having the same lock tag (LockTag) as the rs1_tag value is present in the LockLog table in the case where the next execution instruction of the CPU is “clearLock rs1_tag”, the lock information management unit initializes all lock identifier (lockID) and lock tag (LockTag) values in the row having the same lock tag (LockTag) value as the rs1_tag value and rows, in which values are subsequently set, to 0.

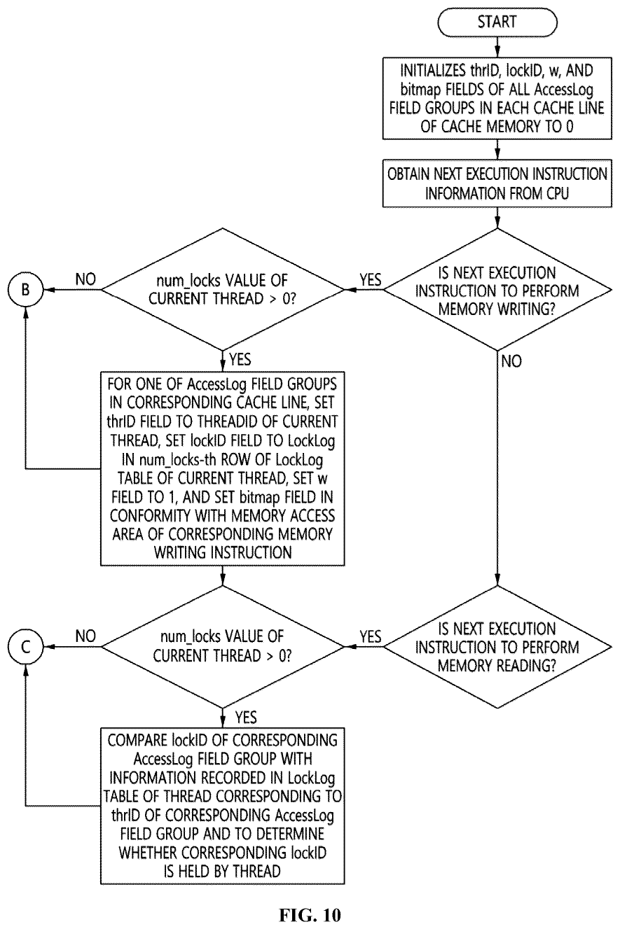

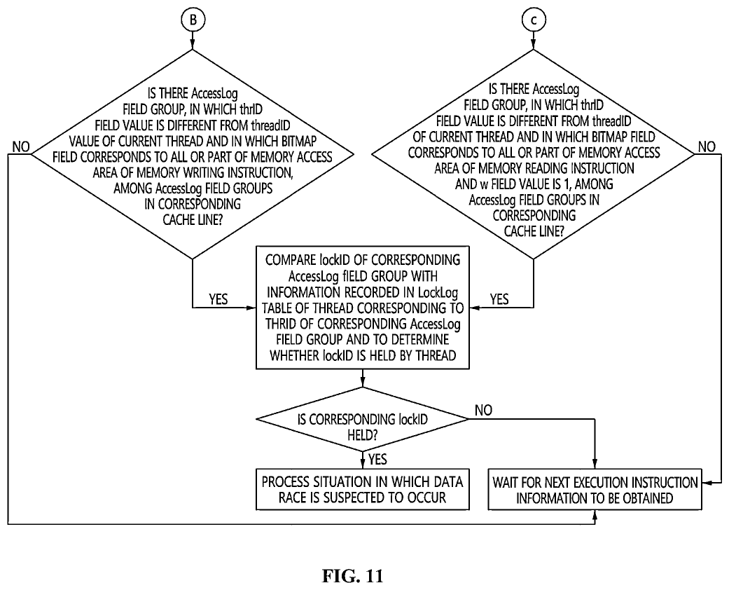

FIGS. 10 and 11 are flowcharts illustrating the operation of a lock identifier (lockID)-based data race detection unit.

The lock identifier (lockID)-based data race detection unit initializes thread identifier (thrID) fields, lock identifier (lockID) fields, writing/non-writing (w) fields, and bitmap fields of all AccessLog field groups in each cache line of the cache memory to 0, as shown in the flowchart, and thereafter operates as follows when a memory writing instruction or a memory reading instruction is executed by the CPU.

### (Initialization)

The lock identifier (lockID)-based data race detection unit determines whether a cache line corresponding to a destination address for memory writing is present when the CPU executes the memory writing instruction. If a cache line corresponding to the destination address for memory writing is not present, the lock identifier (lockID)-based data race detection unit initializes the thread identifier (thrID), lock identifier (lockID), writing/non-writing (w), and bitmap fields of all AccessLog field groups to 0 for a cache line allocated for the corresponding memory writing.

### (Memory Writing-AccessLog Initialization)

Thereafter, when the num_locks value of the current thread is greater than 0, the lock identifier (lockID)-based data race detection unit determines whether AccessLog field group in which the value of the thread identifier (thrID) field is identical to the threadID value of the current thread and in which the bitmap field overlaps the memory access area of the current instruction is present among AccessLog field groups in the corresponding cache line. (memory writing-AccessLog record)

When it is determined that the corresponding AccessLog field group is not present, the lock identifier (lockID)-based data race detection unit selects one of the AccessLog field groups in the corresponding cache line, sets the thread identifier (thrID) field to the threadID of the current thread, sets the lock identifier (lockID) field to a lock identifier (lockID) in the num_locks-th row of the LockLog table of the current thread, sets the writing/non-writing (w) field to 1, and sets the bitmap field in conformity with the memory access area of the current instruction. (memory writing-AccessLog record-new allocation)

When it is determined that there is the AccessLog field group, the lock identifier (lockID)-based data race detection unit sets the w field of the corresponding AccessLog field group to 1 and sets the bitmap field to include the current memory access area. (memory writing-AccessLog record-existing content update)

Thereafter, when the lock identifier (lockID) of the corresponding AccessLog field group is greater than the lock identifier (lockID) in the num_locks-th row of the LockLog table of the current thread, the lock identifier (lockID)-based data race detection unit changes the lock identifier (lockID) field of the corresponding AccessLog field group to the lock identifier (lockID) in the num_locks-th row of the LockLog table.

When the lock identifier (lockID) of the corresponding AccessLog field group is less than or equal to the lock identifier (lockID) in the num_locks-th row, the lock identifier (lockID)-based data race detection unit compares the lock identifier (lockID) of the corresponding AccessLog field group with information recorded in the LockLog table of the current thread to determine whether the corresponding lock identifier (lockID) is held by the thread. When the lock identifier (lockID) is not held by the thread, the lock identifier (lockID) field of the corresponding AccessLog field group is changed to the lock identifier (lockID) in the num_locks-th row of the LockLog table.

Thereafter, the lock identifier (lockID)-based data race detection unit determines whether an AccessLog field group, in which the thread identifier (thrID) field value is different from the threadID value of the current thread and in which the bitmap field corresponds to the memory access area of the memory writing instruction, is present among the AccessLog field groups in the corresponding cache line. (memory writing-existing AccessLog-based data race detection)

When it is determined that the corresponding AccessLog field group is not present, the lock identifier (lockID)-based data race detection unit waits for next execution instruction information to be obtained from the CPU, whereas when the AccessLog field group is present, the lock identifier (lockID)-based data race detection unit compares the lock identifier (lockID) of the corresponding AccessLog field group with information recorded in the LockLog table of the thread corresponding to the thread identifier (thrID) of the corresponding AccessLog field group to determine whether the corresponding lock identifier (lockID) is held by the thread.

When the lock identifier (lockID) is held by the thread, the lock identifier (lockID)-based data race detection unit determines that a data race is suspected to occur and performs suitable processing, whereas when the lock identifier (lockID) is not held by the thread, the lock identifier (lockID)-based data race detection unit waits for next execution instruction information to be obtained from the CPU.

The lock identifier (lockID)-based data race detection unit determines whether a cache line corresponding to a source address for memory reading is present when the CPU executes the memory reading instruction. If a cache line corresponding to the destination address for memory reading is not present, the lock identifier (lockID)-based data race detection unit initializes the thread identifier (thrID), lock identifier (lockID), writing/non-writing (w), and bitmap fields of all AccessLog field groups to 0 for a cache line allocated for the corresponding memory reading. (memory reading-AccessLog initialization)

Thereafter, when the number_locks value of the current thread is greater than 0, the lock identifier (lockID)-based data race detection unit determines whether an AccessLog field group, in which the value of the thread identifier (thrID) field is identical to the threadID value of the current thread and in which the bitmap field corresponds to all or part of the memory access area of the current instruction, is present among AccessLog field groups in the corresponding cache line. (memory reading-AccessLog record)

When it is determined that the corresponding AccessLog field group is not present, the lock identifier (lockID)-based data race detection unit selects one of the AccessLog field groups in the corresponding cache line, sets the thread identifier (thrID) field to the threadID of the current thread, sets the lock identifier (lockID) field to a lock identifier (lockID) in the num_locks-th row of the LockLog table of the current thread, sets the writing/non-writing (w) field to 0, and sets the bitmap field in conformity with the memory access area of the current instruction. (memory reading-AccessLog record-new allocation)

When it is determined that there is the AccessLog field group, the bitmap field of the corresponding AccessLog field group is set to include the current memory access area. (memory reading-AccessLog record-existing content update)

Thereafter, when the lock identifier (lockID) of the corresponding AccessLog field group is greater than the lock identifier (lockID) in the num_locks-th row of the LockLog table of the current thread, the lock identifier (lockID)-based data race detection unit changes the lock identifier (lockID) field of the corresponding AccessLog field group to the lock identifier (lockID) in the num_locks-th row of the LockLog table.

When the lock identifier (lockID) of the corresponding AccessLog field group is less than or equal to the lock identifier (lockID) in the num_locks-th row, the lock identifier (lockID)-based data race detection unit compares the lock identifier (lockID) of the corresponding AccessLog field group with information recorded in the LockLog table of the current thread to determine whether the corresponding lock identifier (lockID) is held by the thread. When the lock identifier (lockID) is not held by the thread, the lock identifier (lockID) field of the corresponding AccessLog field group is changed to the lock identifier (lockID) in the num_locks-th row of the LockLog table.

Thereafter, the lock identifier (lockID)-based data race detection unit determines whether an AccessLog field group, in which the thrID field value is different from threadID of the current thread and in which the bitmap field corresponds to the memory access area of the memory reading instruction (the value of the w field is 1), is present among AccessLog field groups in the corresponding cache line. (memory reading-existing AccessLog-based data race detection)

When it is determined that the corresponding AccessLog field group is not present, the lock identifier (lockID)-based data race detection unit waits for next execution instruction information to be obtained from the CPU, whereas when the AccessLog field group is present, the lock identifier (lockID)-based data race detection unit compares the lock identifier (lockID) of the corresponding AccessLog field group with information recorded in the LockLog table of the thread corresponding to the thread identifier (thrID) of the corresponding AccessLog field group to determine whether the corresponding lock identifier (lockID) is held by the thread.

When the lock identifier (lockID) is held by the thread, the lock identifier (lockID)-based data race detection unit determines that a data race is suspected to occur and performs suitable processing, whereas when the lock identifier (lockID) is not held by the thread, the lock identifier (lockID)-based data race detection unit waits for next execution instruction information to be obtained from the CPU.

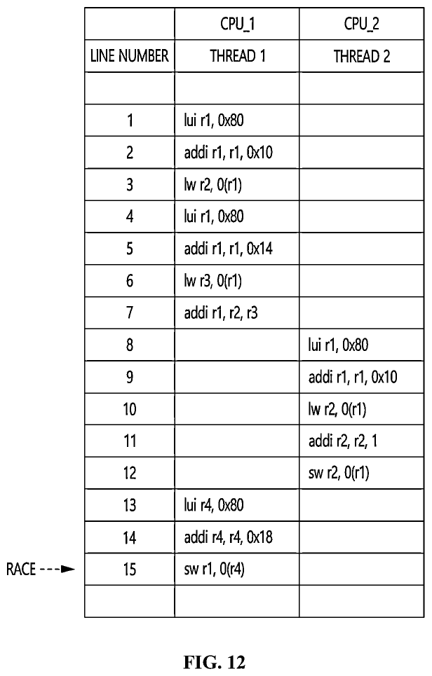

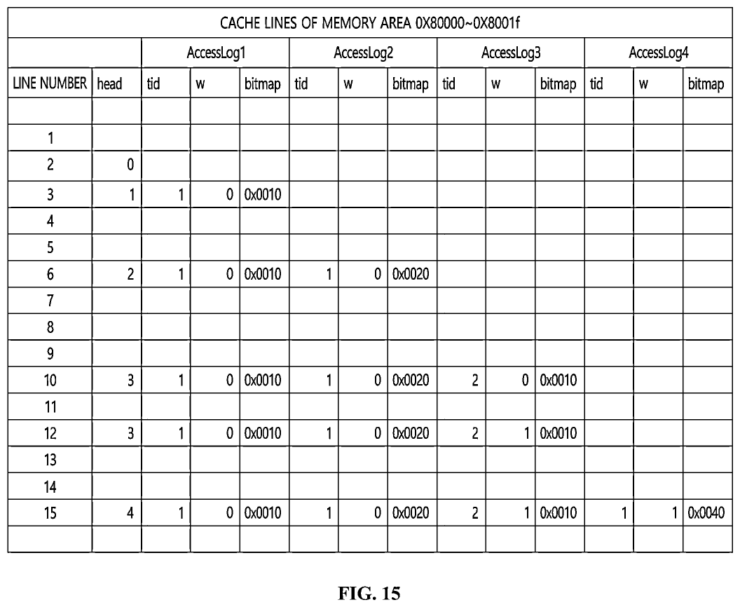

FIGS. 12 to 15 illustrate a first embodiment of a memory source address management unit and a source address (srcAddr)-based data race detection unit.

Threads thread1 and thread2 are executed on CPU1 and CPU2, respectively, wherein thread1 performs a task for reading values at memory addresses 0x80010 and 0x80014, and writing a value obtained by adding the read values to a memory address 0x80018. Simultaneously with thread1, thread2 performs a task for reading a value at the memory address 0x80010, adding 1 to the read value, and rewriting the added value to the memory address 0x80010, and thus a data race occurs at the memory address 0x80010.

The thread thread1 may read values at the memory addresses 0x80010 and 0x80014 into the registers r2 and r3 of CPU1 in code lines 3 and 6, respectively. In this case, the srcAddr1 registers of the registers r2 and r3 may be set to 0x80010 and 0x80014, respectively. Further, when thread1 accesses the memory addresses 0x80010 and 0x80014, thrID fields of AccessLog1 and AccessLog2 field groups in the corresponding cache line are set to 1, w fields thereof are set to 0, and bitmap fields thereof are set to 0x0010 and 0x0020, respectively.

Thereafter, in code line 7, the result of adding the values of r2 and r3 is written to r3, wherein the srcAddr1 register values of r2 and r3 are copied to the srcAddr1 and srcAddr2 of r3.

The thread thread2 reads a value at 0x80010 into r2 of CPU2 in code line 10, wherein the srcAddr1 register value of r2 is set to 0x80010. In code line 11, the value of r2 is increased by 1, and in code line 12, the value of r2 is rewritten to 0x80010.

In code line10, when thread2 performs a read access to the memory address 0x80010, the AccessLog3 field group of the corresponding cache line is set such that the value of the thrID field is 2, the value of the w field is 0, and the value of the bitmap field is set to 0x0010. Thereafter, when a write access to the same address in code line 12 is performed, the value of only the w field in the AccessLog3 field group is changed to 1.

Because the write access is performed in code line 12, data race detection is attempted. However, there is no field group satisfying thrID=2, w=0, and bitmap-0x0010 among AccessLog field groups in the corresponding cache line, and thus it is determined that a data race does not occur.

When in code line 15, thread1 performs writing of the value of r1 to 0x80018, the AccessLog4 field group in the corresponding cache line is set such that thrID=1, w=1, bitmap=0x0040 are satisfied.

Further, in order to perform data race detection, for the srcAddr1 register value (0x80010) and the srcAddr2 register value (0x80020) of r1, AccessLog field groups (AccessLog1 and 2) in which the thrID field value is 1 and the w field value is 0 are present in the corresponding cache line, and a writing log (e.g., AccessLog field group (AccessLog3) in which the thrID field value is not 1 and the w field value is 1) in another thread for 0x80010 is present among AccessLog field groups that are subsequently inserted, and thus a situation in which a data race is suspected to occur is detected.

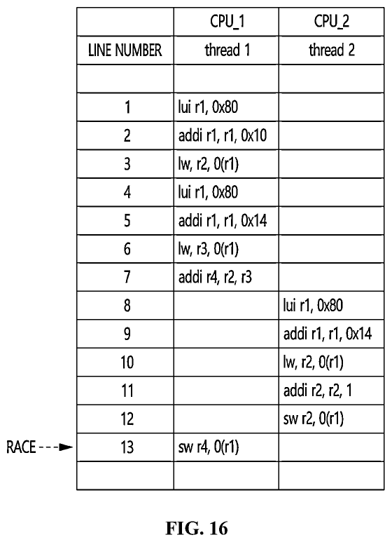

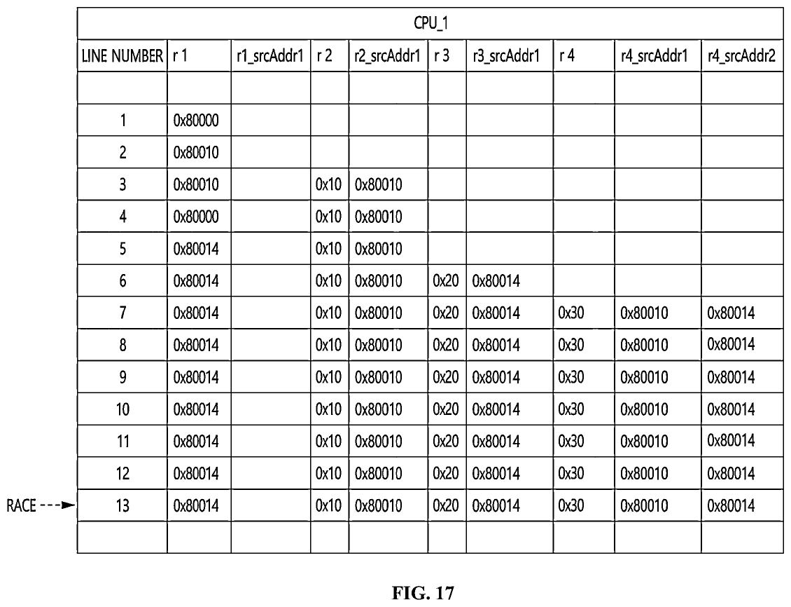

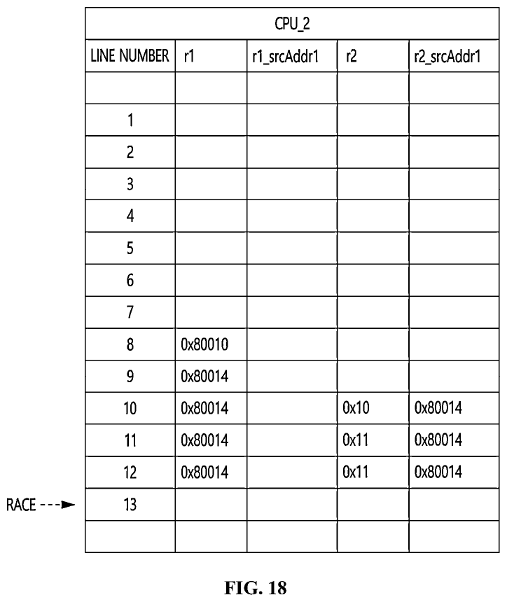

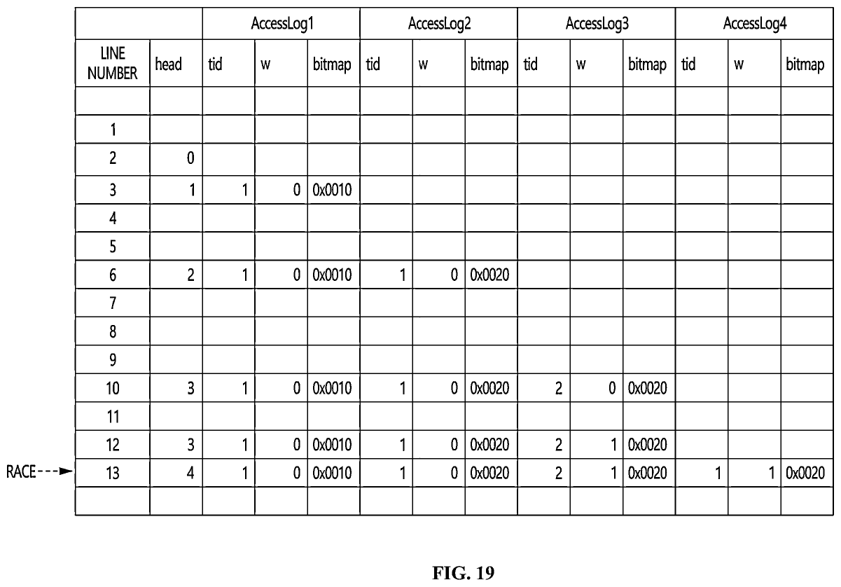

FIGS. 16 to 19 illustrate a second embodiment of a memory source address management unit and a source address (srcAddr)-based data race detection unit.

Threads thread1 and thread2 are executed on CPU1 and CPU2, respectively, wherein thread1 performs a task for reading values at memory addresses 0x80010 and 0x80014, and writing a value obtained by adding the read values to a memory address 0x80014. Simultaneously with thread1, thread2 performs a task for reading a value at the memory address 0x80014, adding 1 to the read value, and rewriting the added value to the memory address 0x80014, and thus a data race occurs at the memory address 0x80014.

The thread thread1 may read values at the memory addresses 0x80010 and 0x80014 into the registers r2 and r3 of CPU1 in code lines 3 and 6, respectively. In this case, the srcAddr1 registers of the registers r2 and r3 may be set to 0x80010 and 0x80014, respectively. Further, when thread1 accesses the memory addresses 0x80010 and 0x80014, thrID fields of AccessLog1 and AccessLog2 field groups in the corresponding cache line are set to 1, w fields thereof are set to 0, and bitmap fields thereof are set to 0x0010 and 0x0020, respectively.

Thereafter, in code line 7, the result of adding the values of r2 and r3 is written to r4, wherein the srcAddr1 register values of r2 and r3 are copied to the srcAddr1 and srcAddr2 of r4.

The thread thread2 reads a value at 0x80014 into r2 of CPU2 in code line 10, wherein the srcAddr1 register value of r2 is set to 0x80014. In code line 11, the value of r2 is increased by 1, and in code line 12, the value of r2 is rewritten to 0x80014.

In code line10, when thread2 performs a read access to the memory address 0x80014, the AccessLog3 field group of the corresponding cache line is set such that the value of the thrID field is 2, the value of the w field is 0, and the value of the bitmap field is set to 0x0020. Thereafter, when a write access to the same address in code line 12 is performed, the value of only the w field in the AccessLog3 field group is changed to 1.

Because the write access is performed in code line 12, data race detection is attempted. However, there is no field group satisfying thrID=2, w=0, and bitmap-0x0020 among AccessLog field groups in the corresponding cache line, and thus it is determined that a data race does not occur.

When in code line 13, thread1 performs writing of the value of r4 to 0x80014, the AccessLog4 field group in the corresponding cache line is set such that thrID=1, w=1, bitmap=0x0020 are satisfied.

Further, in order to perform data race detection, for the srcAddr1 register value (0x80010) and the srcAddr2 register value (0x80014) of r4, AccessLog field groups (AccessLog1 and 2) in which the thrID field value is 1 and the w field value is 0 are present in the corresponding cache line, and a writing log (e.g., AccessLog field group (AccessLog3) in which the thrID field value is not 1 and the w field value is 1) in another thread for 0x80014 is present among AccessLog field groups that are subsequently inserted, and thus a situation in which a data race is suspected to occur is detected.

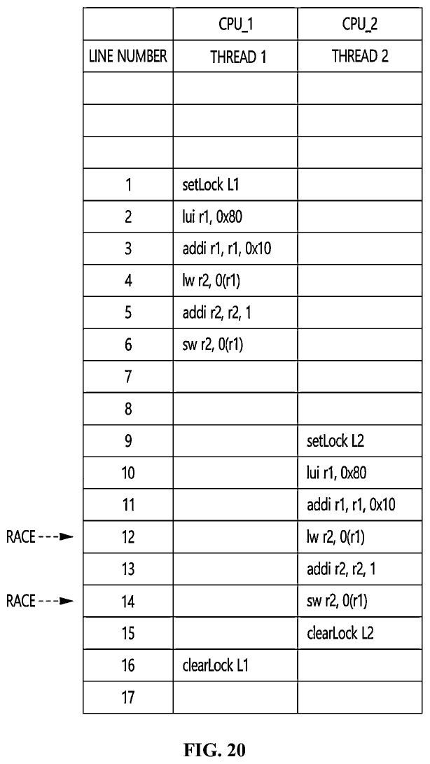

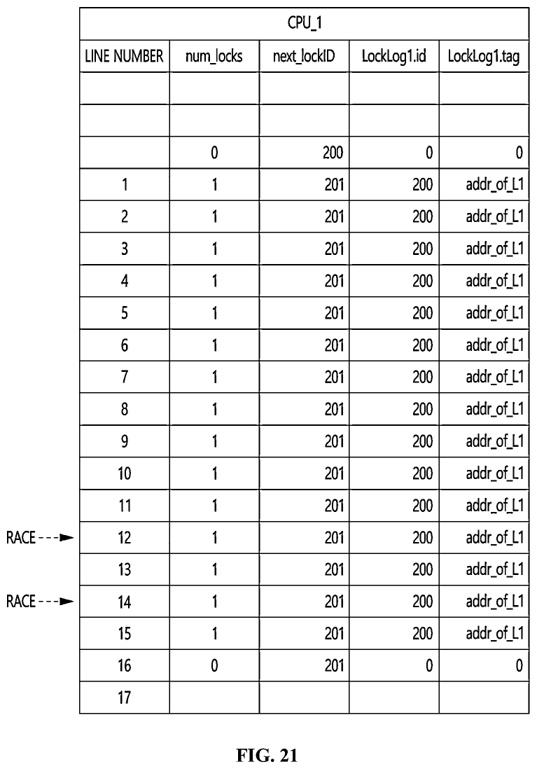

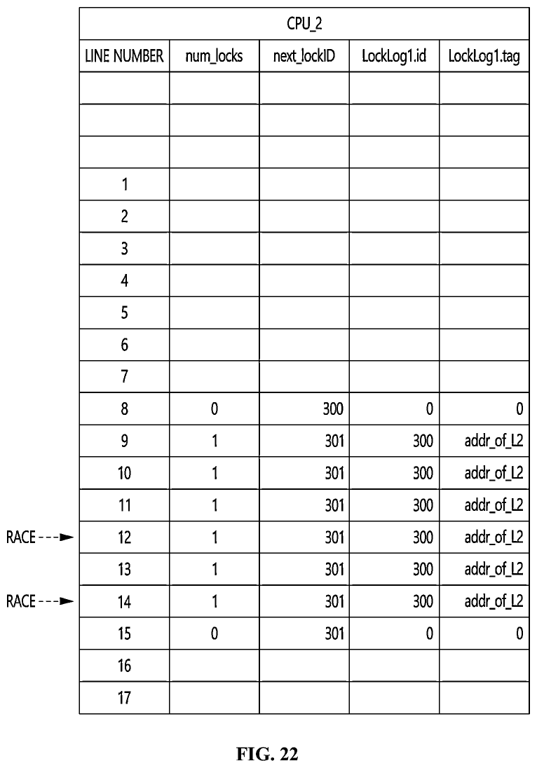

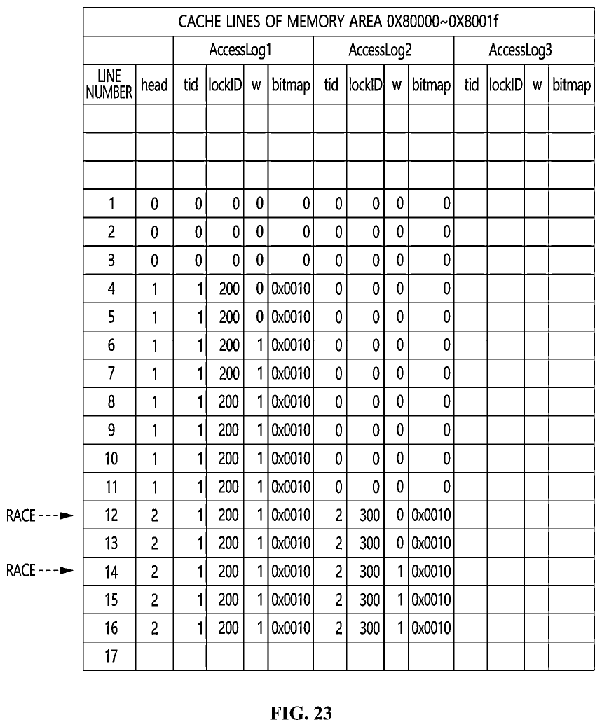

FIGS. 20 to 23 illustrate a first embodiment of a lock information management unit and a lock identifier (lockID)-based data race detection unit.

Threads thread1 and thread2 are executed on CPU1 and CPU2, respectively, wherein thread1 executes code of acquiring a lock using a lock variable L1, reading a value at memory address 0x80010, rewriting a value, obtained by adding 1 to the read value, to the memory address 0x80010, and releasing a lock. Simultaneous with thread1, thread2 executes code of acquiring a lock using a lock variable L2, reading a value at the memory address 0x80010, rewriting a value, obtained by adding 1 to the read value, to the memory address 0x80010, and releasing a lock, and thus a data race occurs at the memory address 0x80010.

The thread thread1 performs “setLock L1” in code line 1, wherein the values of num_locks and next_lockID registers of CPU1 are increased by 1 by the lock information management unit. Also, the id value of LockLog1 that is a first row of the LockLog table is set to the next_lockID value before being increased, and a tag value is set to the address value of the lock variable L1 or a hash value calculated using the address value.

Thereafter, in code line 4, the value at the memory address 0x80010 is read into r2 of CPU1, and the AccessLog1 field group in the corresponding cache line is set such that the thrID value is 1, the w value is 0, and the bitmap value is 0x0010. Thereafter, in code line 6, a write access to the same address is performed, and the value of only the w field in the AccessLog1 field group is changed to 1.

Finally, in code line 16, “clearLock L1” is performed, LockLog1, found by comparing the tag value in each row and the lock variable L1 with each other, is deleted from the LockLog table, and the value of num_locks is decreased by 1.

Thread2 performs “setLock L2” in code line 9, wherein the values of num_locks and next_lockID registers of CPU2 are increased by 1 by the lock information management unit. Also, the id value of LockLog1 that is a first row of the LockLog table is set to the next_lockID value before being increased, and a tag value is set to the address value of the lock variable L2 or a hash value calculated using the address value.

Thereafter, in code line 12, the value at the memory address 0x80010 is read into r2 of CPU1, and the AccessLog2 field group in the corresponding cache line is set such that the thrID value is 2, the w value is 0, and the bitmap value is 0x0010. Thereafter, in code line 14, a write access to the same address is performed, and the value of only the w field in the AccessLog2 field group is changed to 1.

Finally, in code line 15, “clearLock L2” is performed, LockLog1, found by comparing the tag value in each row and the lock variable L1 with each other, is deleted from the LockLog table, and the value of num_locks is decreased by 1.

The lock identifier (lockID)-based data race detection unit searches the AccessLog table in a cache line, corresponding to the memory address 0x80010 accessed when thread2 performs memory reading in code line 12, for a row (i.e., AccessLog1 field group) in which the thrID value is different from that of the current thread, the w field value is 1, and the bitmap field value overlaps the access area.

For the found AccessLog1 field group, the lock identifier lockID 200 is compared with information recorded in the LockLog table of thread1 corresponding to the thrID(1) of the corresponding AccessLog field group to determine whether the corresponding lock identifier lockID 200 is held by the thread. Because the id of LockLog1 that is a first row of the LockLog table is 200, it is determined that the corresponding lock is acquired by the current thread1 and a data race is suspected to occur.

Similarly, in the case where memory writing is performed in code line 14 of thread2, an AccessLog1 field group, in which the thrID field value is different from the threadID of the current thread and the bitmap field value overlaps the access area, may be found in the AccessLog table in a cache line corresponding to the accessed memory address 0x80010. For the found AccessLog1 field group, the lock identifier lockID 200 is compared with information recorded in the LockLog table of thread1 corresponding to thrID(1) of the corresponding AccessLog field group to determine whether the corresponding lock identifier lockID 200 is held by the thread. Because the id of LockLog1 that is a first row of the LockLog table is 200, it is determined that the corresponding lock is acquired by the current thread1 and a data race is suspected to occur.

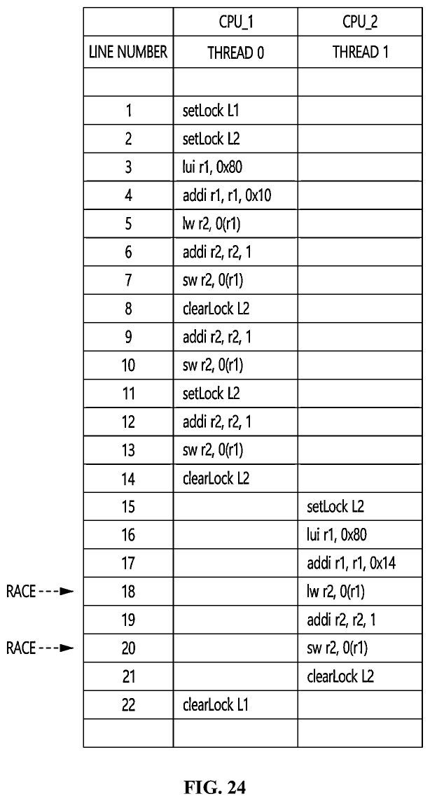

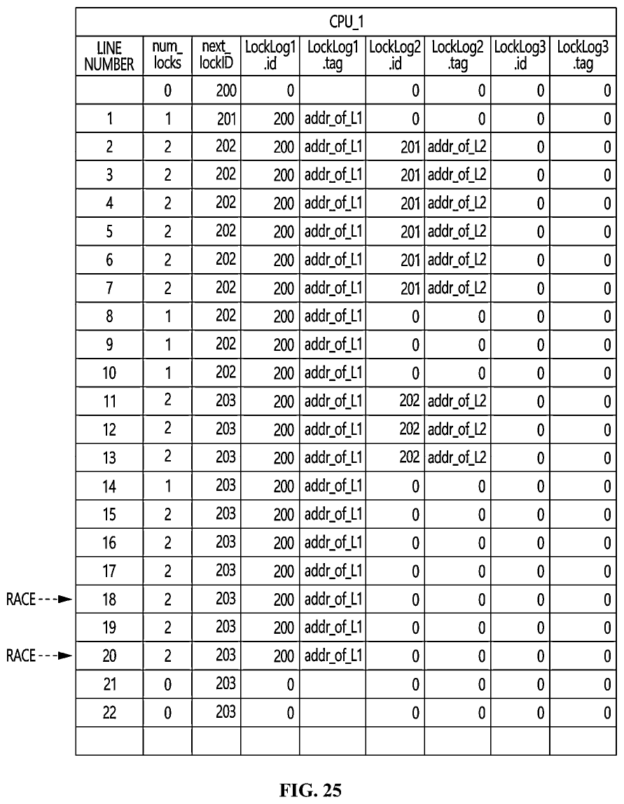

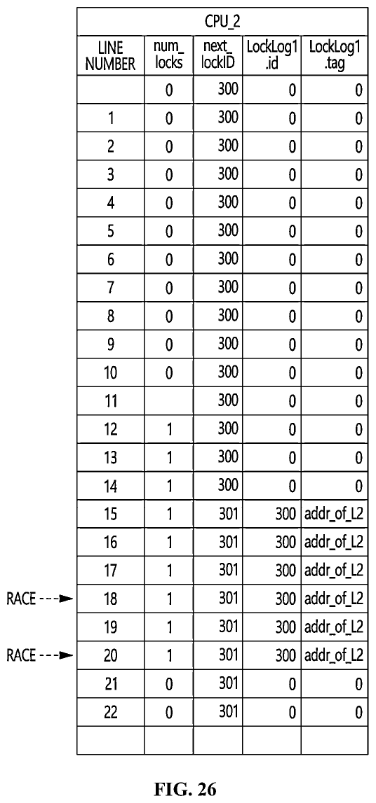

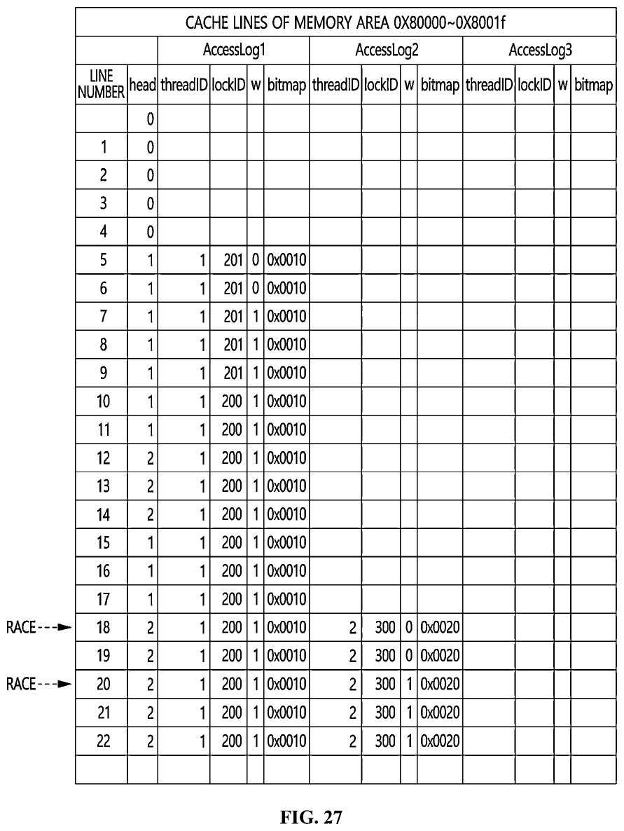

FIGS. 24 to 27 illustrate a second embodiment of a lock information management unit and a lock identifier (lockID)-based data race detection unit.

Thread thread1 executed on CPU1 performs reading and writing at memory addresses 0x80010 and 0x80014 while releasing the lock after acquiring an L2 lock twice in the state in which an L1 lock is acquired. Here, thread2 executed on CPU2 performs reading and writing at memory address 0x80014 in the state in which an L2 lock is acquired, and thus a data race at the memory address 0x80014 occurs.

In code lines 1 and 2, “setLock L1” and “setLock L2” are performed by utilizing L1 and L2 variables, respectively, and thus LockLog1 and LockLog2 are set.

Thereafter, in code line 5, when reading is performed at the memory address 0x80010, an AccessLog1 field group in the corresponding cache line is set, and the lock identifier (lockID) field value among field values is set to the lock identifier (lockID) 201 of the most recently set LockLog2.

Thereafter, in code line 7, the w field of the AccessLog1 field group is changed to 1 while writing to the memory address 0x80010 is performed.

In code line 8, the value of num_locks is decreased by 1 and content of LockLog2 is initialized to 0 while “clearLock L2” is performed.

In code line 10, the lock identifier (lockID) value of the AccessLog1 field group in the corresponding cache line is changed to 200, which is the smaller of the previous value 201 and the recent lock identifier (lockID) value 200 of LockLog, while performing writing to the memory address 0x80010.

In code line 11, the num_locks value is increased by 1 and the lock identifier (lockID) field of LockLog2 is set to 202 by re-performing “setLock L2”.

Thereafter, in code line 13, writing to the memory address 0x80010 is performed, but the lock identifier (lockID) value of the AccessLog1 field group in the corresponding cache line is maintained at 200 that is the smaller of 202 and 200.

Thereafter, the lock identifier (lockID)-based data race detection unit determines that a data race is suspected to occur due to the AccessLog1 field group in the corresponding cache line when performing reading and writing at the memory address 0x80010 in code lines 18 and 20 of thread2.

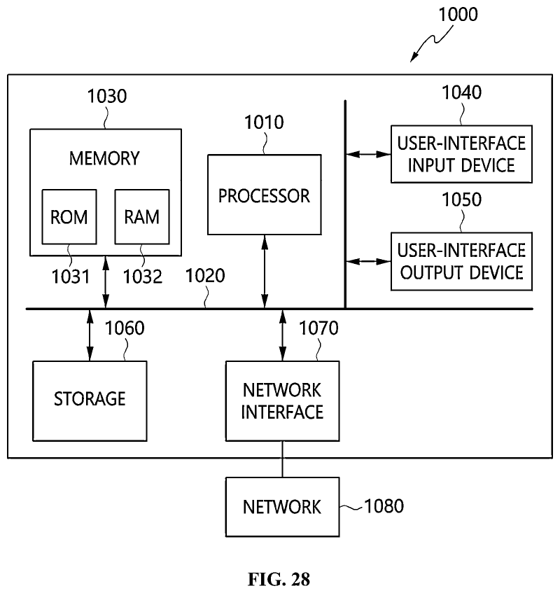

FIG. 28 is a diagram illustrating the configuration of a computer system according to an embodiment.

A data race detection apparatus according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

A data race detection apparatus according to an embodiment of the present disclosure may include one or more processors, and execution memory configured to store at least one program that is executed by the one or more processors, wherein the at least one program includes instructions for performing the step of recording information about an instruction executed by a thread in a destination register in a Central Processing Unit (CPU) corresponding to the thread, the step of setting information of an access log field corresponding to the instruction for a cache line of a cache memory, and the step of detecting a data race using the information of the access log field and information of the destination register.

A data race detection apparatus according to another embodiment of the present disclosure may include one or more processors, and execution memory configured to store at least one program that is executed by the one or more processors, wherein the at least one program includes instructions for performing the step of, in response to a lock setting instruction or a lock release instruction of a thread, managing lock information in a CPU corresponding to the thread, the step of setting information in an access log field corresponding to the instruction of the thread for a cache line of cache memory, and the step of detecting a data race using the information of the access log field and the lock information.

Specific executions described in the present disclosure are embodiments, and the scope of the present disclosure is not limited to specific methods. For simplicity of the specification, descriptions of conventional electronic components, control systems, software, and other functional aspects of the systems may be omitted. As examples of connections of lines or connecting elements between the components illustrated in the drawings, functional connections and/or circuit connections are exemplified, and in actual devices, those connections may be replaced with other connections, or may be represented by additional functional connections, physical connections or circuit connections. Furthermore, unless definitely defined using the term “essential”, “significantly” or the like, the corresponding component may not be an essential component required in order to apply the present disclosure.

According to the present disclosure, there can be provided a method for accurately detecting a data race while having low overhead.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A data race detection method performed by a data race detection apparatus, the data race detection method comprising:
recording information about an instruction executed by a thread in a destination register in a Central Processing Unit (CPU) corresponding to the thread;
setting information of an access log field corresponding to the instruction for a cache line of a cache memory; and
detecting a data race using the information of the access log field and information of the destination register.

2. The data race detection method of claim 1, wherein the access log field includes a thread identifier (ThrID) field, a writing/non-writing (W) field, and a bitmap field.

3. The data race detection method of claim 2, wherein setting the information in the access log field comprises:
when the instruction performs memory writing, entering a thread in which an instruction is executed into the thread identifier field, entering true (1) into the writing/non-writing field, and entering information into the bitmap field to correspond to an area of the instruction for performing memory writing.

4. The data race detection method of claim 3, wherein detecting the data race comprises:
determining whether there is a cache line corresponding to a source address of a general-purpose register having a source value of the instruction for performing the memory writing.

5. The data race detection method of claim 4, wherein detecting the data race further comprises:
when there is the cache line corresponding to the source address of the general-purpose register, determining whether there is a first access log in which a thread identifier field of the cache line is identical to a thread identifier of a thread executing the instruction and in which a value of a writing/non-writing field is false (0) and a bitmap field corresponds to an area of the instruction for performing the memory writing.

6. The data race detection method of claim 5, wherein detecting the data race further comprises:
in a case where there is the first access log, determining that the data race has occurred when, among access logs inserted after the first access log, there is a second access log in which the thread identifier field of the cache line is different from the thread field of the thread executing the instruction and in which the value of the writing/non-writing field is true (1) and the bitmap field corresponds to the area of the instruction for performing the memory writing.

7. The data race detection method of claim 1, wherein recording the information in the designation register in the CPU comprises:
when executing an instruction for loading data from a memory into the destination register of the CPU, recording a memory address; and
when executing an instruction for writing a result of an operation to the destination register using a value of a source register, copying an address register value of the source register to an address register of the destination register.

8. The data race detection method of claim 7, wherein copying the address register value to the address register of the destination register comprises:
when multiple source register values are used, coping address register values corresponding to the multiple source register values, respectively.

9. The data race detection method of claim 7, wherein copying the address register value to the address register of the destination register comprises:
inputting 0 to the address register of the destination register when a constant is used as an operand.

10. A data race detection method performed by a data race detection apparatus, the data race detection method comprising:
in response to a lock setting instruction or a lock release instruction of a thread, managing lock information in a Central Processing Unit (CPU) corresponding to the thread;
setting information in an access log field corresponding to an instruction of the thread for a cache line of a cache memory; and
detecting a data race using the information of the access log field and the lock information.

11. The data race detection method of claim 10, wherein:
the lock information includes a next lock identifier (next_lockID) register value, a number-of-locks (num_locks) register value, and a lock log table, and
the lock log table includes a lock identifier (lockID) field and a lock tag (LockTag) field.

12. The data race detection method of claim 11, wherein the access log field includes a thread identifier (ThrID) field, a writing/non-writing (W) field, and a bitmap field.

13. The data race detection method of claim 12, wherein managing the lock information comprises:
when the instruction of the thread corresponds to the lock setting instruction, setting a lock identifier (LockID) value to the next lock identifier (next_lockID) register value, setting a lock tag (LockTag) value to a source register tag value, and increasing the next lock identifier (next_lockID) register value and the number-of-locks (num_locks) register value by 1.

14. The data race detection method of claim 12, wherein detecting the data race comprises:
when the instruction of the thread performs memory writing, determining whether there is an access log in which a thread identifier field of the cache line is different from a thread identifier of the thread executing the instruction, and a bitmap field includes a memory access area of the instruction for performing the memory writing.

15. The data race detection method of claim 12, wherein detecting the data race comprises:
when the instruction of the thread performs memory reading, determining whether there is an access log in which a thread identifier field of the cache line is different from the thread identifier of the thread executing the instruction and in which the bitmap field includes a memory access area of the instruction for performing memory reading and a value of the writing/non-writing field is true (1).

16. The data race detection method of claim 15, wherein detecting the data race further comprises:
checking whether the lock identifier is in an occupied state based on the lock log table corresponding to the thread identifier field value of the cache line.

17. A data race detection apparatus, comprising:
one or more processors; and
an execution memory configured to store at least one program that is executed by the one or more processors,
wherein the at least one program comprises instructions for performing:
recording information about an instruction executed by a thread in a destination register in a Central Processing Unit (CPU) corresponding to the thread;
setting information of an access log field corresponding to the instruction for a cache line of a cache memory; and
detecting a data race using the information of the access log field and information of the destination register.
